(19) United States
(12) Patent Application Publication
(10) Pub. No.: US 2018/0049431 A1
(43) Pub. Date: Feb. 22, 2018

(54) Antibacterial composite and method for preparing the same

(71) Applicant: National Taiwan University, Taipei (TW)

(72) Inventors: Chung-Yuan Mou, Taipei City (TW); Yi-Ting Chen, Taipei City (TW); Yi-Ping Chen, Taipei City (TW)

(21) Appl. No.: 15/665,547

(22) Filed: Aug. 1, 2017

Related U.S. Application Data
(60) Provisional application No. 62/376,921, filed on Aug. 19, 2016.

(51) Int. Cl. A01N 25/08; A01N 59/16; A01N 63/00

(52) U.S. Cl. CPC A01N 25/08; C12Y 302/01017; A01N 63/00; A01N 59/16

(57) ABSTRACT

The present invention provides a composite that consists essentially of a mesoporous silica substrates and silver nanoparticles. In particular, the mesoporous silica substrate comprises a mesoporous silica thin film with perpendicular nanochannels and mesoporous silica nanoparticles with perpendicular nanochannels and the silver nanoparticles non-covalently bond onto surface of the mesoporous silica substrate and have a distribution density of 10⁷-10¹³ number/cm² on the surface. The preparing method and antibacterial application of the composite are also disclosed in the present invention.

### TECHNICAL FIELD OF THE INVENTION

The present invention relates to a composite consisting essentially of a mesoporous silica substrates and silver nanoparticles. In particularly, the composite is an antibacterial composite. Furthermore, the present invention discloses a method for preparing the aforementioned composite and application thereof.

### BACKGROUND OF THE INVENTION

Microbial infection raised from food, water, and contact has been an important global issue concerning public security and health. Different approaches of novel antibacterial agents as alternatives to antibiotics have been reported that cationic polymers, polypeptides, enzyme and inorganic nanoparticles have showed promising antibacterial activities.

U.S. Pat. No. 7,893,104 disclose a one-pot polyol process for making particle complexes. The process is a sol-gel process to form a particle suspension.

U.S. Pat. No. 8,318,698 disclose an antimicrobial compound comprises a plurality of silica particles and a plurality of clusters of silver metal chemically bound to a surface of each of the plurality of silica particles.

U.S. Pat. No. 9,491,946 disclose a silver loaded silica nanoparticles formulation containing about 10-24 wt % silver, however, the silver is in the silica matrix.

However, an antibacterial composite which comprises a substrate has large specific surface area, size controllability, ordered porous structure, good thermal stability, easy functionalization, and biocompatibility is still needed to develop in this area.

Based on the aforementioned, a composite consisting of silica substrates with ordered porous structure and antibacterial agent, such as silver nanoparticles and enzyme is highly demanded in the future.

### SUMMARY OF THE INVENTION

In one aspect, the present invention disclosed a composite. The composite consists essentially of a mesoporous silica substrates and silver nanoparticles, wherein the mesoporous silica substrate comprises a mesoporous silica thin film with perpendicular nanochannels and mesoporous silica nanoparticles with perpendicular nanochannels and wherein the silver nanoparticles non-covalently bond onto surface of the mesoporous silica substrate and have a distribution density of 10⁷-10¹³ number/cm² on the surface.

Typically, the composite has a two-dimension hexagonal packing diffraction pattern with the space group of p6 mm in FFT-TEM (fast Fourier transform) analysis and the formation of well-distributed silver nanoparticles (AgNPs) without utilization of capping agents, keeping the AgNPs highly active as well as preventing them from aggregation. Also, with the adsorption between functionalized silica surface and AgNPs, fairly low consumption of silver ions could be observed during a long-term usage test.

In another aspect, the present invention provides a process for preparing an antibacterial composite, the process comprises the steps of: (1). Provide a mesoporous silica substrate comprises a mesoporous silica thin film with perpendicular nanochannels and mesoporous silica nanoparticles with perpendicular nanochannels; (2). Treat the mesoporous silica substrate with an silane to obtain an amino functionalizing silica substrate, wherein the silane form Si—O bonds on the mesoporous silica substrate; (3). Add a silver ion precursor into a medium contains the amino functionalizing silica substrate; and (4). Add a reductant to have the silver ion precursor in the medium form silver nanoparticles, wherein the silver nanoparticles non-covalently bond onto surface of the amino functionalizing silica substrate to construct an antibacterial composite which has a distribution density of the silver nanoparticles being 10⁷-10¹³ number/cm² on the surface of the amino functionalizing silica substrate.

Generally, the mesoporous silica substrate with perpendicular nanochannels is prepared from alkyl silane, tetraethoxysilane (TEOS), tetramethoxysilane, fumed silica, zeolite seeds, sodium silicate, or a silane precursor that can produce silicate, silicic acid or silicic acid like intermediates and a combination of these silane compounds.

In order to modify both external and internal surface of the mesoporous silica substrate with different kinds of functional groups, the mesoporous silica substrate was reacted with various functionalized silanes by post-modfication. The silane comprises (3-aminopropyl)trimethoxysilane, N-[3-(trimethoxysilyl)propyl]ethylenediamine.

In still another aspect, the present invention provides a method for inhibiting growth of bacteria on surfaces, the method comprises the steps of: (1). Provide a composition comprises an effective concentration of one selected from the group consisting of an antibacterial enzyme-silica biocomposites, silver-silica composites and its combination thereof and (2). Coat the composition onto surfaces of a substrate to inhibit growth of the bacteria on the surfaces.

Preferably, the antibacterial enzyme-silica biocomposites are lysozyme-silica biocomposites

For achieving good antibacterial results, the lysozyme-silica biocomposites comprise 50-3000 mg of lysozyme per gram of the lysozyme-silica biocomposites.

Typically, the invented silver-silica composites have a concentration of released the silver ion less than 0.6 ppm. Such low silver releasing indicates that the invented silver-silica composites do not suffer from a great loss of silver during bactericidal process, apparently different from traditional antibacterial composites.

Accordingly, the present invention disclosed a novel mesoporous silica substrate with perpendicular nanochannels for physically immobilizing two different antibacterial agents, silver nanoparticles (AgNPs) for broadly bactericidal utility and lysozyme as a natural bacteriolytic enzyme on its surface. The present invention also provides the unique method for preparing the silver-silica composite and antibacterial application for both Gram-positive and Gram-negative bacilli.

### BRIEF DESCRIPTION OF THE DRAWINGS

FIG. 1 is a SEM image of the invented mesoporous silica thin film with perpendicular nanochannels prepared in the Example 1;

FIG. 2 is a TEM image of the invented mesoporous silica thin film with perpendicular nanochannels prepared in the Example 1 Insert: Fast Fourier Transform-TEM image;

FIG. 3 is XRD pattern of the invented mesoporous silica thin film with perpendicular nanochannels prepared in the Example 1;

FIG. 4 is N₂ adsorption-desorption isotherms (inset: corresponding pore size distribution plots) of the invented mesoporous silica thin film with perpendicular nanochannels prepared in the Example 1;

FIG. 5 is FTIR spectra of SBA-15 (black line), SBA-15_NH(CH₂)₂NH₂_{_}Ag (blue line), and SBA-15_NH₂_{_}Ag (red line) disclosed in the present invention, respectively;

FIG. 6(a) is TEM image of silver-silica composites synthesized with AgNO_{3(aq)} concentration of 0.2 mM, and FIG. 6(b) is TEM image of silver-silica composites synthesized with AgNO_{3(aq)} concentration of 1.0 mM in the present invention;

FIG. 7(a) is TEM image of SBA-15_NH(CH₂)₂NH₂_{_}Ag, and FIG. 7(b) is TEM image of SBA-15_NH₂_{_}Ag disclosed in the present invention;

FIG. 8(a) is size distribution histograms of AgNPs on SBA-15_NH(CH₂)₂NH₂_{_}Ag and FIG. 8(b) is size distribution histograms of AgNPs on SBA-15_NH₂_{_}Ag disclosed in the present invention;

FIG. 9 is XRD patterns of SBA-15_NH(CH₂)₂NH₂_{_}Ag (blue line), and SBA-15_NH₂_{_}Ag (red line) disclosed in the present invention, respectively;

FIG. 10 is UV-vis spectra of SBA-15 (black line), SBA-15_NH(CH₂)₂NH₂_{_}Ag (blue line), and SBA-15_NH₂_{_}Ag (red line) disclosed in the present invention, respectively;

FIG. 11 is Silver ion releasing profile of SBA-15_NH₂_{_}Ag disclosed in the present invention;

FIG. 12 is XRD patterns of SBA-15 (green line), SBA-15_Hy (red line), and MSN_Ex (blue line) disclosed in the present invention, respectively;

FIG. 13 is N₂ adsorption-desorption isotherms (inset corresponding pore size distribution plots) of SBA-15 (green line), SBA-15_Hy (red line), and MSN_Ex (blue line) disclosed in the present invention, respectively;

FIG. 14 is Histogram of lysozyme adsorbed by SBA-15_Hy at pH 4.6, 6.8, and 9.5 disclosed in the present invention, respectively;

FIG. 15 is Histogram of lysozyme adsorbed by SBA-15_Hy with 20, 100, and 500 mM sodium phosphate buffer disclosed in the present invention, respectively;

FIG. 16 is Adsorption curves of representative lysozyme-silica composites of SBA-15_Lyz (green line), SBA-15_Hy_Lyz (red line), and MSN_Ex_Lyz (blue line) disclosed in the present invention, respectively;

FIG. 17 is Histograms of lysozyme-loading capacities of representative composites of SBA-15_Lyz (green bar), SBA-15_Hy_Lyz (red bar), and MSN_Ex_Lyz (blue bar) disclosed in the present invention, respectively;

FIG. 18 is N₂ adsorption-desorption isotherms (inset corresponding pore size distribution plots) of SBA-15_Lyz (green line), SBA-15_Hy_Lyz (red line), and MSN_Ex_Lyz (blue line) disclosed in the present invention, respectively;

FIG. 19 is Time-dependent lysozyme leaching profiles of of SBA-15_Lyz (green line), SBA-15_Hy_Lyz (red line), and MSN_Ex_Lyz (blue line) disclosed in the present invention, respectively;

FIG. 20(a) is FL image of bacterial strains treated with SBA-15_Hy and subsequently stained with SYTO 9 (green), FIG. 20(b) is FL image of bacterial strains treated with SBA-15_Hy and subsequently stained with PI (red), FIG. 20(c) is FL image of bacterial strains treated with SBA-15_Hy_Lyz and subsequently stained with SYTO 9 (green), and FIG. 20(d) is FL image of bacterial strains treated with SBA-15_Hy_Lyz and subsequently stained with PI (red); and

FIG. 21 is a photo of SBA-15_Hy_Lyz marked with No. 1 and SBA-15_Hy marked with No. 2 after bacterial incubation.

### BRIEF DESCRIPTION OF THE PREFERRED EMBODIMENTS

In a first embodiment, the present invention disclosed a composite. The composite consists essentially of a mesoporous silica substrates and silver nanoparticles, wherein the mesoporous silica substrate comprises a mesoporous silica thin film with perpendicular nanochannels and mesoporous silica nanoparticles with perpendicular nanochannels and wherein the silver nanoparticles non-covalently bond onto surface of the mesoporous silica substrate and have a distribution density of 10⁷-10¹³ number/cm² on the surface.

In one example of the first embodiment, the mesoporous silica substrate has an average pore diameter ranges between 2 and 15 nm.

In one example of the first embodiment, the composite has a two-dimension hexagonal packing diffraction pattern with the space group of p6 mm in FFT-TEM (fast Fourier transform) analysis.

In one example of the first embodiment, the surface of the mesoporous silica substrate comprises amino group.

In one example of the first embodiment, the silver nanoparticles have an average diameter less than 20 nm.

In one example of the first embodiment, the composite is part of an antibacterial paint, medical device or sanitary equipment.

In one example of the first embodiment, the antibacterial paint apply to one comprises cell culture dish, endoscopy, denture, surgical instrument and medical device.

In a second embodiment, the present invention provides a process for preparing an antibacterial composite, the process comprises the following steps: (1). Provide a mesoporous silica substrate comprises a mesoporous silica thin film with perpendicular nanochannels and mesoporous silica nanoparticles with perpendicular nanochannels; (2). Treat the mesoporous silica substrate with a silane to obtain an amino functionalizing silica substrate, wherein the silane form Si—O bonds on the mesoporous silica substrate; (3). Add a silver ion precursor into a medium contains the amino functionalizing silica substrate; and (4). Add a reductant to have the silver ion precursor in the medium form silver nanoparticles. The silver nanoparticles non-covalently bond onto surface of the amino functionalizing silica substrate to construct an antibacterial composite which has a distribution density of the silver nanoparticles being 10⁷-10¹³ number/cm² on the surface of the amino functionalizing silica substrate.

In one example of the second embodiment, the silane comprises (3-aminopropyl)trimethoxysilane, N-[3-(trimethoxysilyl)propyl]ethylenediamine.

In one example of the second embodiment, the silver ion precursor is silver nitrate. Preferably, a concentration of the silver nitrate is 0.1-3.0 mM.

In one example of the second embodiment, the reductant comprises 0.1-10 mM of sodium borohydride.

In a third embodiment, the present invention provides a method for inhibiting growth of bacteria on surfaces, the method comprises: (1). Provide a composition comprises an effective concentration of one selected from the group consisting of an antibacterial-silica biocomposites, silver-silica composites and its combination thereof; and (2). Coat the composition onto surfaces of a substrate to inhibit growth of the bacteria on the surfaces.

Preferably, the antibacterial-silica biocomposites are the lysozyme-silica biocomposites.

In one example of the third embodiment, the lysozyme-silica biocomposites consist of a lysozyme and a mesoporous silica substrate selected from a mesoporous silica thin film with perpendicular nanochannels and mesoporous silica nanoparticles with perpendicular nanochannels, wherein an average pore diameter of the mesoporous silica substrate is between 1 and 15 nm.

In one example of the third embodiment, the lysozyme-silica biocomposites comprise 50-3000 mg of lysozyme per gram of the lysozyme-silica biocomposites.

In one example of the third embodiment, the silver-silica composites have a concentration of released the silver ion less than 0.6 ppm.

In one example of the third embodiment, the silver-silica composites consist of silver nanoparticles and a mesoporous silica substrate selected from a mesoporous silica thin film with perpendicular nanochannels and mesoporous silica nanoparticles with perpendicular nanochannels, wherein an average pore diameter of the mesoporous silica substrate is between 1 and 15 nm.

In one example of the third embodiment, the silver nanoparticles non-covalently bond onto surface of the mesoporous silica substrate and have a distribution density of 10⁷-10¹³ number/cm² on the surface and an average diameter less than 20 nm.

In one preferred example of the third embodiment, the mesoporous silica substrate has amino group on its surfaces.

In one example of the third embodiment, the substrate comprises plastic, rubber, metal, ceramic, glass, swab, cotton, and cloth.

Accordingly, the present invention provides unique mesoporous silica materials with perpendicular nanochannels as supports for physically immobilizing two different antibacterial agents, AgNPs for broadly bactericidal utility and lysozyme as a natural bacteriolytic enzyme.

The following working examples disclose the invention in more detail, but not limit to the scope of the claims.

### Example 1: Synthesis of a Mesoporous Silica Thin Film with Perpendicular Nanochannels (SBA-15(⊥) Thin Film)

A mesoporous silica thin film with perpendicular nanochannels as denoted as SBA-15(⊥) Thin film is synthesized by the following procedure. SBA-15(⊥) thin film was synthesized in an acidic condition using a ternary-surfactant system as a template and sodium silicate as the silica source. The ternary-surfactant system consisted of cetyltrimethyl ammonium bromide ((C₁₆H₃₃)N(CH₃)₃Br, CTAB), sodium dodecyl sulfate (NaC₁₂H₂₅SO₄, SDS) and poly(ethylene glycol)-block-poly(propylene glycol)-poly(ethylene glycol) (EO₂₀PO₇₀EO₂₀, P123). In this method, 0.75 g of CTAB, 0.89 g of SDS and 0.7 g of P123 were mixed in 150 g H₂O under stirring at 45° C., and the pH value was adjusted to by sulfuric acid (H₂SO₄) and sodium hydroxide (NaOH). As for the silica source, 2.75 g sodium silicate was dissolved in 150 g 0.04 M H₂SO₄ aqueous solution, followed by adjusting the pH value to 4.3 with NaOH. Then, the silicate solution was poured into the surfactant solution, and a cloudy solution was formed after aging at 45° C. To enlarge nanochannels, the as-synthesized precipitates were further hydrothermally treated in mother solution at 120° C. for 24 hours. The products were collected by filtration, and were calcined at 600° C. for 6 hours for removal of the organic templates.

Characterization Analysis

Scanning Electron Microscopy (SEM)

SEM images were performed on a Hitachi S-800 field emission scanning electron microscope operated at an accelerating voltage of 5 kV. Samples were fixed on a specimen mount holder with adhesion of carbon tapes. The specimens were dried under vacuum before SEM imaging.

Transmission Electron Microscopy (TEM)

TEM images were recorded on a Hitachi H-7100 transmission electron microscope operated at an accelerating voltage of 75 kV. Samples dispersed in ethanol or water were deposited on carbon-coated copper grids and dried under air atmosphere before TEM imaging.

Powder X-Ray Diffraction (XRD)

Powder X-ray diffraction patterns were collected on a PANalytical X' Pert PRO diffractometer with Cu K_{α} radiation at λ=0.154 nm. The machine was operated at 45 kV and 40 mA. For low angle XRD scanning (2θ=0.5°-8°), the divergent slit was 1/32 degree. For wide angle XRD scanning (2θ=10°-80°), the divergent slit was ½ degree. Powder samples were ground with a mortar and loaded on a holder for measurements.

Nitrogen Adsorption-Desorption Analysis

Nitrogen adsorption-desorption isotherms were obtained by a Micrometric ASAP 2010 apparatus at 77 K. Specific surface areas were evaluated by BET (Brunauer-Emmett-Teller) method in a linear relative pressure range from 0.05 to 0.3. The pore size was the peak position of a pore distribution plot collected from the analysis of adsorption isotherm by BJH (Barrett-Joyner-Halenda) method. Pore volumes were estimated by single point adsorption at relative pressure 0.993.

Zeta-Potential

Zeta potential (ζ) is defined as the electrical potential between the inner Helmholtz layer near a particle's surface and the bulk liquid in which the particle is suspended. It is a parameter that represents the charge of a particle in given condition, like suspended in deionic water here. Zeta-potential of particles were measured with a Zatasizer Nano ZS90 (Malvern Instrument). Powder were dispersed in deionic water as a sample solution. 800 μL of the solution were loaded into a zeta cell.

Fourier Transform Infrared Spectroscopy (FTIR)

FT-IR spectra were carried out on a Nicolet 550 spectrometer. Samples were blended with KBr at a weight ratio of 1:200 and made into a tablet for measurement. The spectra were measured in a wavenumber range from 400 to 4000 cm⁻¹.

Ultraviolet-Visible (UV-Vis) Spectroscopy

UV-vis absorption spectra were measured with a Hitachi U-3010 spectrophotometer. Solid samples dispersed in de-ionic water were load in a quartz cell and an integrating sphere was included to collect the reflected light. The spectra were collected in a wavelength range from 300 to 700 nm.

Inductively Coupled Plasma Mass Spectrometry (ICP-MS)

Quantitative Ag analyses were determined by using a Perkin-Elmer Alan-6000 instrument. Typically, powder samples or solution with metal ions were digested sequentially in hydrofluoric acid and aqua regia. The solution was diluted for measurements.

Characterizations of the Mesoporous Silica Thin Film with Perpendicular Nanochannels (SBA-15(⊥) Thin Film) Prepared in Example 1

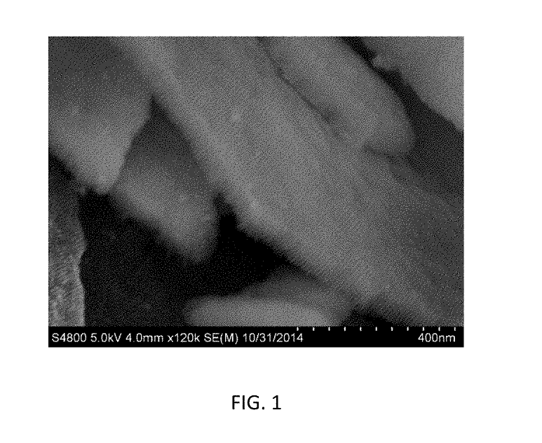

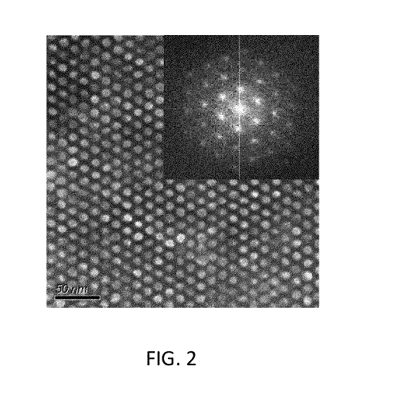

FIG. 1 shows SEM and FIG. 2 shows TEM images of representative SBA-15(⊥) thin films, respectively. The materials were particulate sheets, few micron meters in lateral dimension and about 100 nm in thickness. While taking a closer look at FIG. 1 (side-view of the SBA-15(⊥) thin films) and FIG. 2 (top-view of the SBA-15(⊥) thin films), it can be seen that the thin films had perpendicular cylindrical nanochannels with fully opened pore entrance. These mesopores were uniform in size (ca. 9 nm) and in regular hexagonal arrangement over the thin films.

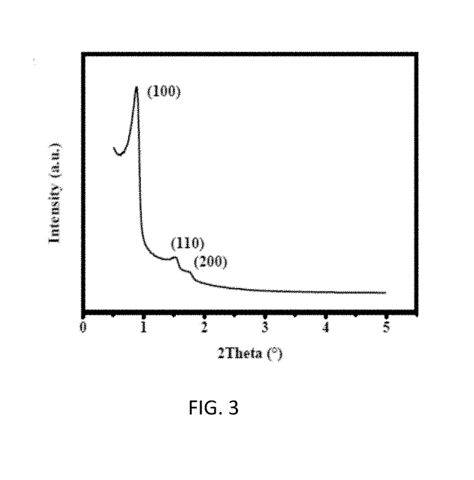

XRD pattern of the SBA-15(⊥) thin films is displayed in FIG. 3 Three reflection peaks at 0.90°, 1.5°, and 1.7° can be observed, showing a periodic length (also known as d-spacing) ratio of 2:\sqrt{3}:1 that is typical for materials having hexagonal arrangements. The explicit peaks also indicate a well ordered rather than non-ordered or worm-like structure of the nanochannels over the silica.

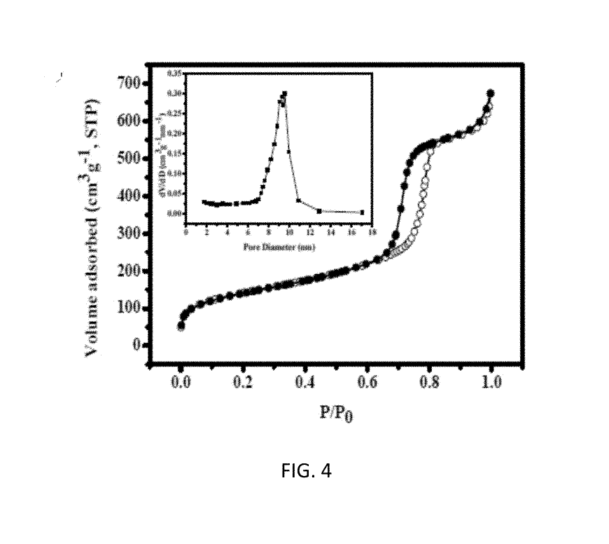

Surface textures were measured using nitrogen adsorption-desorption analysis as shown in FIG. 4, and the results are summarized in Table 1. The thin films reveal type IV adsorption branch with H₁ type hysteresis loop, which are signatures for materials having uniform cylindrical mesopore architectures. Furthermore, the materials present specific surface area of 507 m²/g and pore volume of 0.93 cm³/g with a uniform pore size distribution centered around 9.6 nm (see the inset of FIG. 4). These characteristics of high surface area, large pore volume, large pore size, and short periodic nanochannels with perpendicular orientation are favorable for silver immobilization.

TABLE 1

| | S_{BET} | Dₚₒᵣₑ | Vₜ | a₀ | w |
|---|---|---|---|---|---|
| Sample | (m²/g)^{a} | (nm)^{b} | (cm³/g)^{c} | (nm)^{d} | (nm)^{e} |
| SBA-15(⊥) | 507 | 9.6 | 0.93 | 11.4 | 1.8 |

^{a}surface area calculated by BET method at relative pressure of P/P0 = 0.05 − 0.3
^{b}pore size calculated by BJH method from adsorption branch of isotherms
^{c}mesopore volume deduced from BJH adsorption cumulative volume of pores between 1.0 nm and 30 nm
^{d}value of unit cell parameter
^{e}wall thickness

### Example 2: Functionalization of the Mesoporous Silica Thin Film with Perpendicular Nanochannels

In order to modify both external and internal surface of SBA-15(⊥) thin film with different kinds of functional groups, the calcined mesoporous silica was reacted with various functionalized silanes by post-modfication. A general procedure was described as following.

1 g SBA-15(⊥) thin film was added into a solution composed of 500 mL ethanol and 5 mL of a silane. The mixture was refluxed under stirring at 80° C. for 24 hours. The final products were obtained by filtration and dryness.

(3-aminopropyl)trimethoxysilane (APTMS), N-[3-(trimethoxysilyl)propyl]ethylenediamine (EDPTMS), 3-(trimethoxysilyl)propyl-N,N,N-trimethylammonium chloride (TMAC) and (3-mercaptopropyl)-trimethoxysilane (MPTMS) were used in example 2, respectively and the related final products were denoted as SBA-15 (1) NH₂, SBA-15(⊥)_NHCH₂CH₂NH₂, SBA-15(⊥)_N(CH₃)₃OH and SBA-15(⊥)_SH, respectively. The SBA-15(⊥)_SH further treat oxidants to obtain SBA-15(⊥)_SO₃H. The SBA-15(⊥) thin film has hydroxyl groups on its surface and is denoted as SBA-15(⊥)_OH. The silane reacted with the hydroxyl groups to form Si—O bonds on surfaces of the SBA-15(⊥).

### Example 3: Preparation of the Invention Composite

A representative procedure for preparing the composite is as follows. 1 mg native and functionalized SBA-15(⊥) thin films were individually suspended in 2 mL 1.0 mM AgNO₃ aqueous solution. The mixtures were stirred at room temperature in darkness for 2 hours. Then 0.2 mL 20 mM iced NaBH₄ aqueous solution was added into each solution. The mixed solution was under continuous stirring for another 1 hour. Each precipitate was washed with deionized water and separated by centrifugation and dryness. Each sample is denoted as SBA-15_X_Ag (X functional group).

Another method of forming silver nanoparticle on the native and functionalized SBA-15(⊥) thin films (or the other type of nanoparticle or thin films) is soaking the SBA-15(⊥) thin films in 2 mL 1.0 mM AgNO_{3(aq)}. The mixtures were stirred at room temperature in darkness for 2 hours. The SBA-15(⊥) thin films were calcined at 150° C. for silver 12 hours to form the silver nanoparticle on the SBA-15(⊥) thin films.

Characterization of the Invention Composite Prepared in Example 3

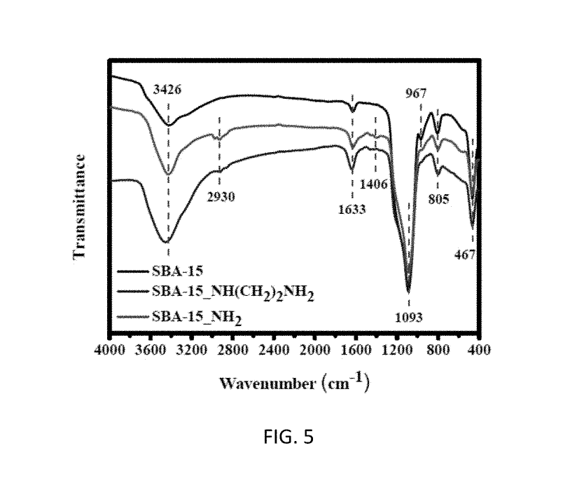

In order to prove the successful functionalization with APTMS and EDPTMS, FTIR spectroscopy was performed. FIG. 5 shows FTIR spectra of each sample, and the corresponding assignments are summarized in Table 2. For native SBA-15, the obvious absorption bands from —OH (νₛ, 3426 cm⁻¹), Si—O—Si (νₐₛ, 1093 cm⁻¹; νₛ, 805 cm⁻¹), Si—OH (νₛ, 967 cm⁻¹), Si—O (δ, 467 cm⁻¹), and H₂O, (δ, 1633 cm⁻¹) are presented (where νₛ represents symmetric stretching, νₐₛ as asymmetric stretching, and δ as bending). Compared with typical silica, characteristic peaks of SBA-15_NH(CH₂)₂NH₂_{_}Ag and SBA-15_NH₂_{_}Ag at 2930 and 1406 cm⁻¹ are related to stretching and bending vibrations of aliphatic C—H bonds, verifying the surface modification with amines. Besides, shrinkage of the band Si—OH at 967 cm⁻¹ is also observed, which is another proof of post-modification of SBA-15(⊥) thin films.

TABLE 2

| Functional groups | Characteristic peaks |
|---|---|
| OH group | 3426 |
| CH group | 2930/1406 |
| H₂O | 1633 |
| Si—O—Si | 1093/805 |
| Si—OH group | 967 |
| Si—O | 467 |

Table 3 shows the zeta potential of each sample, SBA-15_X (X: functional group). Sample SBA-15_OH without functionalization and SBA-15_SO₃H with functionalization of sulfonic acid had negative zeta potential of −33 and −27 mV, respectively. Due to the influence of modfication degree and pKa of functional groups, these two samples had similar strengths of zeta potential. However, SBA-15(⊥) thin films functionalized various with amine groups exhibited different strengths of positive zeta potentials. SBA-15_NH(CH₂)₂NH₂ and SBA-15_NH₂ that were functionalized with secondary and primary amines showed 2 and 12 mV, respectively. As for SBA-15_N(CH₃)₃OH, which was post-modified with tertiary amines, the sample revealed a more positive potential of 31 mV.

TABLE 3

| Sample | Zeta potential (mV) |
|---|---|
| SBA-15_OH | −33 |
| SBA-15_SO₃H | −27 |
| SBA-15_NH(CH₂)₂NH₂ | 2.0 |
| SBA-15_NH₂ | 12 |
| SBA-15_N(CH₃)₃OH | 31 |

Size Regulation of the Silver Nanoparticles: The Effect of Different Amount of Silver Precursor

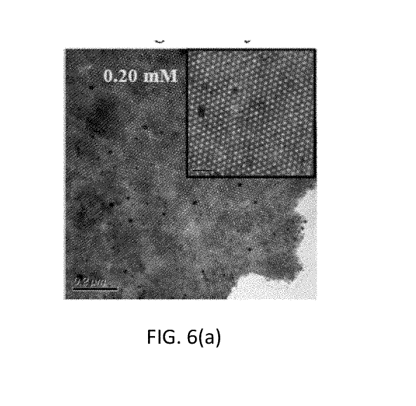

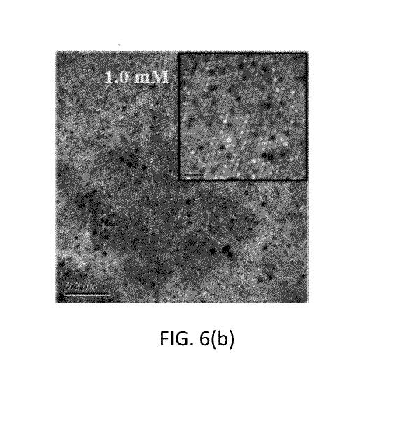

Under constant amounts of silica and reductant, a series of AgNO_{3(aq)} with different concentrations (0.20, 0.50, 1.0, and 1.5 mM) were applied. TEM images show results of AgNPs reduced on SBA-15_NH₂ under different amount of silver precursor. As shown in FIG. 6(a), when AgNO_{3(aq)} was at low concentration of 0.20 mM, AgNPs with small dimension around 7.8(±1.6) nm were rarely generated. When the concentration was up to 0.5 mM, more AgNPs with size around 8.2(±1.7) nm were produced on the silica supports, about 1.7×10¹¹ particles per square centimeter. As shown in FIG. 6(b), when AgNO_{3(aq)} was at 1.0 mM, silica films got AgNPs with similar size about 8.6(±1.6) nm but with larger amounts, up to 6.7×10¹¹ per square centimeter anchored on the surface with uniform distribution. While the concentration was increased to 1.5 mM, AgNPs with larger size about 17(±5) nm were formed. Apparently, with a lower concentration of silver precursor, smaller AgNPs were facilitated. Accordingly, AgNPs with dimension below 10 nm were generated when the concentration of silver was below 1.0 mM. In order to get as many as small AgNPs on silica, the experimental condition with 1.0 mM AgNO_{3(aq)} was taken in the following synthesis. All the experimental data was list in Table 4.

TABLE 4

| | AgNO₃ | NaBH₄ | Size | Distribution density |
|---|---|---|---|---|
| Sample | (mM) | (mM) | (nm) | (#/cm²) |
| a) | 0.20 | 2.0 | 7.8(±1.6) | 6.1 × 10⁷ |
| b) | 0.50 | 2.0 | 8.2(±1.7) | 1.7 × 10¹¹ |
| c) | 1.0 | 2.0 | 8.6(±1.6) | 6.7 × 10¹¹ |
| d) | 1.5 | 2.0 | 17(±5) | 2.6 × 10¹⁰ |

Size Regulation of the Silver Nanoparticles: The Effect of Different Amount of Reductant

To optimize the reducing condition, the concentration of reductant was also adjusted. Under constant amounts of silica and 1.0 mM AgNO_{3(aq)}, a series of NaBH_{4(aq)} with different concentrations (0.40, 1.0, 2.0, and 6.0 mM) were utilized. At low concentration of 0.40 mM, there was almost no AgNPs reduced on silica. When the concentration was up to 1.0 mM, AgNPs with large dimension of 22(±6) nm were derived. At 2.0 mM, SBA-15(⊥) thin films got much more AgNPs with small dimension of 8.6(±1.6) nm, about 6.7×10¹¹ particles per square centimeter. While it was increased to 6.0 mM, massive amounts of 7.3×10¹¹/cm² AgNPs with the smallest particle size of 6.9(±1.3) nm could be synthesized. Nevertheless, the silica frameworks were destroyed under the basic condition. Due to the requirement of as many small AgNPs as possible without collapse of silica supports, the condition with 1.0 mM AgNO_{3(aq)} and 2.0 mM NaBH_{4(aq)} were used in the following experiments. All the experimental data was list in Table 5.

TABLE 5

| | AgNO₃ | NaBH₄ | Size | Distribution density |
|---|---|---|---|---|
| Sample | (mM) | (mM) | (nm) | (#/cm²) |
| a) | 1.0 | 0.40 | — | — |
| b) | 1.0 | 1.0 | 22(±6) | 2.3 × 10¹⁰ |
| c) | 1.0 | 2.0 | 8.6(±1.6) | 6.7 × 10¹¹ |
| d) | 1.0 | 6.0 | 6.9(±1.3) | 7.3 × 10¹¹ |

Distribution of Silver Nanoparticles on the Mesoporous Silica Thin Film

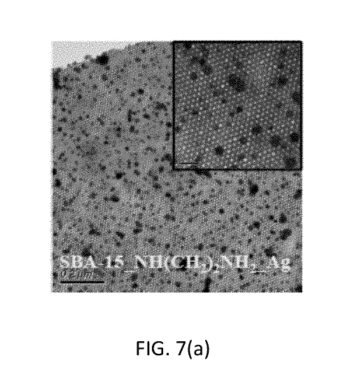

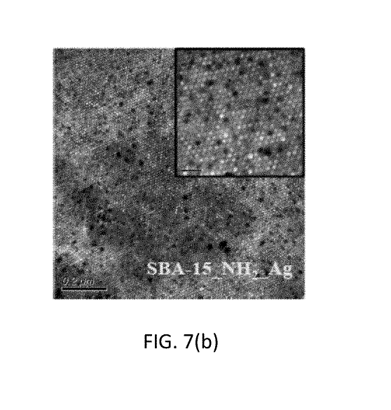

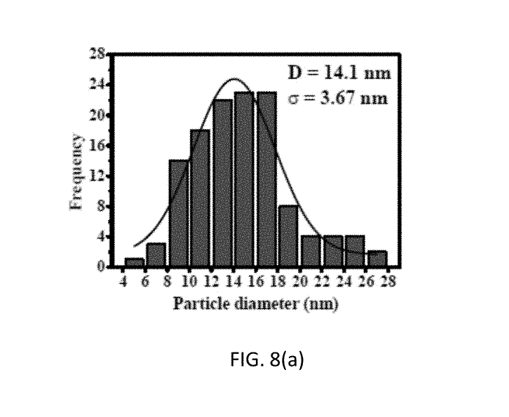

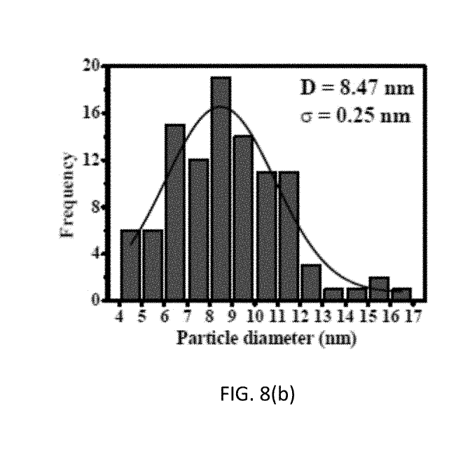

SBA-15_OH_Ag and SBA-15_SO₃H_Ag that illustrated negative surface potential could not get AgNPs adsorbed on silica. Although these thin films could attract silver ions via electrostatic force at first, they would have a repulsive interaction against the reduced AgNPs that had negative surface potential. This is believed to be the reason why there was no AgNP available on silica with a negative zeta potential. On the other hand, SBA-15_NH(CH₂)₂NH₂_{_}Ag which has TEM image as shown in FIG. 7(a) and SBA-15_NH₂_{_}Ag which has TEM image as shown in FIG. 7(b) that exhibited positive zeta potentials demonstrated massive AgNPs reduced on the surfaces. To confirm the dimensions of AgNPs on the two samples, the size distributions were recorded statistically as demonstrated in FIG. 8(a) for SBA-15_NH(CH₂)₂NH₂_{_}Ag and FIG. 8(b) for SBA-15_NH₂_{_}Ag. Accordingly, it can be seen that SBA-15_NH(CH₂)₂NH₂_{_}Ag had bigger AgNPs with diameters about 14(±3.7) nm, while SBA-15_NH₂_{_}Ag revealed smaller ones around 8.5(±0.25) nm. This variation in size is believed to associate with coordination degree of lone pairs of amine groups to silver ion. SBA-15_NH(CH₂)₂NH₂_{_}Ag with a low positive potential had relatively weak repulsion to silver ion so as to get a condition with rich silver ion for growth of AgNPs to bigger. Whereas SBA-15_NH₂_{_}Ag with a more positive potential may have less silver ion surrounding nucleation sites due to the strong electrostatic repulsion between silica and silver ion. As a result, there was no overgrowth of AgNPs on SBA-15_NH₂_{_}Ag. However, SBA-15_N(CH₃)₃OH, which had the most positive zeta potential among the samples, had only a few AgNPs immobilized in thin films, probably due to the quaternary ammonium functional groups. The lack of lone pairs of the functional groups makes the materials unable to coordinate free silver ions, accordingly AgNPs were barely derived.

Furthermore, using different reducing condition could make different size of silver nanoparticle forming on the silica support. The silica support (SBA-15_NH₂) is soaking in 2 mL 1.0 mM AgNO_{3(aq)} solution and the mixtures were stirred at room temperature in darkness for 2 hours. The SBA-15_NH₂ thin films were calcined at 150° C. for 12 hours to form the silver nanoparticle on the SBA-15_NH₂ thin films. After calcination, the color of SBA-15_NH₂ thin films was change from white to blackish green. The size of silver nanoparticle is smaller than 2 nm and evenly distributed on the thin film.

XRD Characterization of the Composite Prepared in Example 3

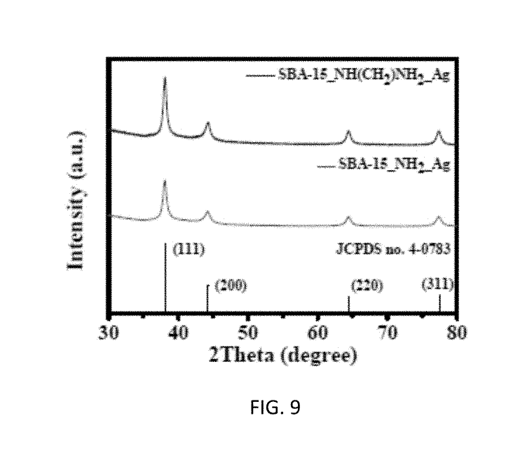

XRD patterns were collected to verify the presence of silver in thin films. FIG. 9 shows wide angle XRD patterns of each sample. The diffraction peaks at 38.1°, 44.1°, 64.3°, and 77.4° in curve of SBA-15_NH(CH₂)₂NH₂_{_}Ag and SBA-15_NH₂_{_}Ag correspond to the (1 1 1), (2 0 0), (2 2 0), and (3 1 1) diffraction planes of face-centered cubic silver [JCPDS no. 4-0783], respectively. These peaks were further analyzed by Scherrer equation for estimating the crystallite sizes, and the results are summarized in Table 6. It shows that the evaluated crystal sizes of SBA-15_NH(CH₂)₂NH₂_{_}Ag and SBA-15_NH₂_{_}Ag are individually around 12-15 and 11-13 nm, well consistent with the previous TEM observations in FIGS. 8(a) and 8(b).

TABLE 6

| Sample | Crystal size |
|---|---|
| SBA-15_NH₂(CH₂)₂NH_{2—}Ag | 12-15 |
| SBA-15_NH_{2—}Ag | 11-13 |

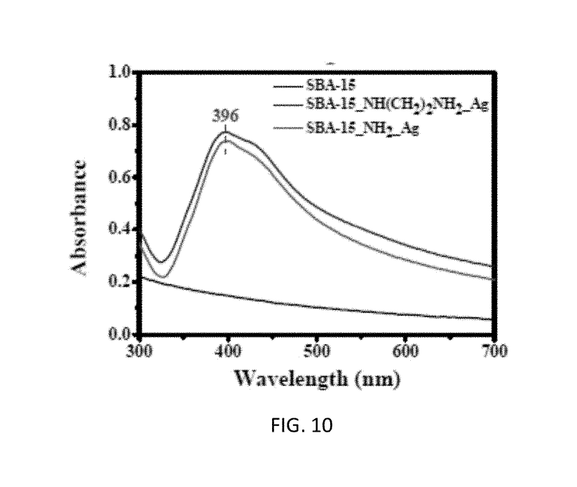

When the dimension of AgNPs is below 15 nm, there would be an extinction peak around 400 nm due to surface plasma resonance of the nanosized silver. As can be seen in FIG. 10, there was no adsorption peak in the spectrum of native SBA-15. By contrast, SBA-15_NH₂_{_}Ag and SBA-15_NH(CH₂)₂NH₂_{_}Ag both showed explicit absorption bands at 396 nm. The existence of extinction peaks, once again, provides evidence of the successful production of nanosized silver on the silica thin films.

Antibacterial Performance Study: MIC and MBC Test

To study antibacterial activities, minimum inhibition concentration (MIC) and minimum bactericidal concentration (MBC) tests against Escherichia coli were carried out. In the MIC tests, a serial diluted solutions of silver-silica composites were prepared and incubated with equivalent bacteria, and a final concentration of strain was controlled around 5×10⁶ CFU/mL in each tube. The mixture would become turbid with overgrowth of bacteria after incubation at 37° C. for 24 hours. The lowest concentration of antibacterial composites in solution that was clear without visible growth of colony was defined as MIC. After the MIC tests, 100 μL solution from each tube were subcultured onto agar plates for MBC tests. If there were no colony formation on plates, the concentration of subculturing solution would be defined as MBC.

The MIC and MBC qualitative test of SBA-15_NH(CH₂)₂NH₂_{_}Ag and SBA-15_NH₂_{_}Ag were performed by eye's observation and the procedure was described as follows. Firstly, there are six tubes prepared with 0, 0.8, 0.9, 1.0, 1.1 and 1.2 mg/mL of SBA-15_NH(CH₂)₂NH₂_{_}Ag, respectively, and with equivalent bacteria in each solution. The first solution without antibacterial agent was served as a negative control. For tubes #1, #2, #3, and #4, the solutions were turbid, representing overgrowth of bacteria and thus no inhibition effect. On the other hand, when the concentration of antibacterial composites was increased to 1.1 mg/mL in tube #5, the solution became clear, which means the concentration of tube #5 was at MIC. Though, the agar plate subcultured with the solution still exhibited some colonies. Yet, no colonies were found on the agar plate spread with solution from tube #6, indicating that the concentration of tube #6 was at MBC. In a similar way, a serial concentration of 0, 0.5, 0.6, 0.7, 0.8 and 0.9 mg/mL of SBA-15_NH₂_{_}Ag were prepared in tubes. Solutions in tube #1 and #2 were muddy, whereas it was clear without visible colony in the other tubes that had SBA-15_NH₂_{_}Ag with a concentration above 0.6 mg/mL. Besides, the solution in tube #4 was subcultured onto an agar plate, and there was no colony forming on the plate, indicating that there was no viable bacterium survive in tube #4.

The quantitative representations of MIC and MBC from composites to silver concentration, silver loading amount in each composite sample was measured via ICP-MS to take quantitative silver analysis. Table 7 presents the reorganization of experimental database. SBA-15_NH(CH₂)₂NH₂_{_}Ag with 14 nm-AgNPs had a MIC of 1.1 mg/mL (equal to 18 μg Ag/mL) and a MBC of 1.2 mg/mL (equal to 19 μg Ag/mL). SBA-15_NH₂_{_}Ag with smaller 8.5 nm-AgNPs had a MIC of 0.6 mg/mL (equal to 7.2 μg Ag/mL) and a MBC of 0.7 mg/mL (equal to 8.4 μg Ag/mL). It is considered that owing to the smaller size of AgNPs with larger surface area for silver ion releasing, SBA-15_NH₂_{_}Ag had a relatively low MIC in comparison to SBA-15_NH(CH₂)₂NH₂_{_}Ag. In the following studies, as a result, SBA-15_NH₂_{_}Ag was selected for further bacterial inhibition tests.

TABLE 7

| | Silver | | | | |
|---|---|---|---|---|---|
| | Loading | | | | |
| | weight | MIC | | MBC | |
| Sample | (%) | (mg/mL) | (μg Ag/mL) | (mg/mL) | (μg Ag/mL) |
| a | 1.6 | 1.1 | 18 | 1.2 | 19 |
| b | 1.2 | 0.6 | 7.2 | 0.7 | 8.4 |

a SBA-15_NH(CH₂)₂NH_{2—}Ag
b SBA-15_NH_{2—}Ag

To perform simple demonstration of antimicrobial application, the silver-silica composites were coated on different substrates and the effects were evaluated by ISO testing. The corresponding antibacterial activity (R) was calculated showing in Table 8 and 9. For an excellent antimicrobial product, its antibacterial activity is generally above 2.

ISO 22196: Measurement of Antibacterial Activity for Hard Substrates

For test on hard substrates, SBA-15_NH₂_{_}Ag was spin-coated on glass slides and examined using ISO 22196. A control group was a glass slide without coating of the composites. Both glass slides with and without silver-silica composites were incubated with equivalent amount of E. coli. After incubation at 37° C. and relative humidity above 95% for 24 hours, bacteria growing on substrates were washed down, and the washing solution was diluted, spreading on agar plates for colony counting. For the control group, the concentration strain was around 2×10⁷ CFU/cm² on the glass slide, and its logarithm was 7.2. By contrast, SBA-15_NH₂_{_}Ag had no colony forming, therefore its logarithm was below 0. For a ISO 22196 test, an antibacterial activity is defined by subtraction of logarithms of number of colony forming units per square centimeter between the experimental and controlled samples. Therefore, the antibacterial activity for SBA-15_NH₂_{_}Ag was above 7.2 as shown in Table 8

TABLE 8

| Inoculum | Cell count after 24 h | Cell count after 24 h |
|---|---|---|
| density | untreated specimens | treated specimens |
| (CFU/mL) | (CFU/cm²) | (CFU/cm²) |
| 5 × 10⁵ | N_{U} = 2 × 10⁷ | N_{A} ≦ 1 |
| | Uₜ = log N_{U} = 7.2 | Aₜ = log N_{A} ≦ 0 |

Antibacterial activity R = Uₜ − Aₜ ≧ 7.2

ISO 20743: Measurement of Antibacterial Activity for Soft Substrates

As another demonstration on soft substrates, a gauze swab was dip-coating with SBA-15_NH₂_{_}Ag and another clean gauze swab was served as a control group. Each gauze swab was incubated with equivalent amount of bacteria, and after incubation the viable cell of bacteria were washed out and diluted for colony counting by an agar plate culture method. It shows the result that the control group had much colony formation but SBA-15_NH₂_{_}Ag had no colony on the plate. For the control group, there were about 6×10⁹ CFU/mL in the inoculum after incubation, and its logarithm was 9.8. For SBA-15_NH₂_{_}Ag, no colony was observed that the logarithm was below 0. Similarly, an antibacterial activity in a ISO 20743 is a subtraction of logarithms for number of colony forming units per milliliter. Accordingly, the antibacterial activity for SBA-15_NH₂_{_}Ag was above 9.8 showing in Table 9.

TABLE 9

| Inoculum | Cell count after 24 h | Cell count after 24 h |
|---|---|---|
| density | untreated specimens | treated specimens |
| (CFU/mL) | (CFU/mL) | (CFU/mL) |
| ~10⁵ | Cₜ = 6 × 10⁹ | Tₜ ≦ 1 |
| | F = log Cₜ = 9.8 | G = log Tₜ ≦ 0 |

Antibacterial activity A = F − G ≧ 9.8

Silver-Releasing Tests

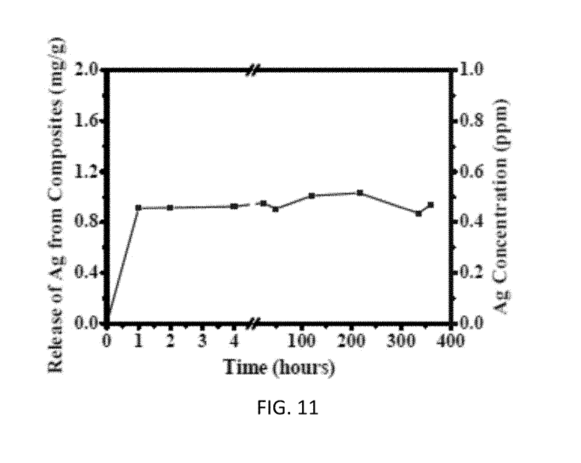

The stability experiment of silver concentration was studied by submitting SBA-15_NH₂_{_}Ag to in vitro silver release for as long as two weeks in phosphate buffered saline solution with pH 7.4 at 37° C. The cumulative released silver amount measured by ICP-MS is reported as a function of time in FIG. 11. The silver release profile showed an initial burst effect in the first hour and then stayed as a plateau to an equilibrium concentration. It can be seen that the amount of released silver was less than 0.94 milligrams of silver per gram of silver-silica composites, equal to 0.47 ppm of silver in the solution. Such low silver releasing indicates that the composites will not suffer from a great loss of silver during bactericidal process, apparently different from the other antimicrobial composites.

Antibacterial Activities Against Clinical Microorganisms

For medical applications, a further research about bacterial inhibition against clinical microorganisms was performed to evaluate the antimicrobial activities of silver-silica composites. According to Nature protocols, experiments were implemented to assess MICs of SBA-15_NH₂_{_}Ag against various clinical bacteria with inoculum of 5×10⁵ CFU/mL. Several bacterial species including but not limited to gram-negative bacilli and gram-positive cocci were used for tests. For gram-negative bacilli, there were Acinetobacter baumannii (ATCC 19606), Klebsiella pneumoniae (ATCC 13883), Escherichia coli (ATCC 25922) and Pseudomonas aeruginosa (ATCC 27853). Gram-positive cocci included Enterococcus faecalis (ATCC 29212), Enterococcus faecium (ATCC 19434) and Staphylococcus aureus (ATCC 25923). Each testing against different bacteria was duplicated. In addition to the MIC of silver-silica composites, the MIC of silver only was also calculated via silver loading weight % of composites measured by ICP. Table 10 shows MICs of SBA-15_NH₂_{_}Ag against various clinical microorganisms. Due to broadly bactericidal abilities without specificity, SBA-15_NH₂_{_}Ag had a fairly low MIC of 0.0125 mg/mL (equal to 0.15 μg Ag/mL) against most of gram-negative bacteria, such as A. baumannii, K. pneumoniae and P. aeruginosa. Exclusively, SBA-15_NH₂_{_}Ag had a lower MIC of 0.00625 mg/mL (equal to 0.075 μg Ag/mL) against E. coli. On the other hand, there were different consequences for various gram-positive bacteria. SBA-15_NH₂_{_}Ag had a higher MIC of 0.1 mg/mL (equal to 1.2 μg Ag/mL) against E. faecalis, and a low MIC of 0.00625 mg/mL (equal to 0.075 μg Ag/mL) against E. faecium. Specially, SBA-15_NH₂_{_}Ag had a extremely low MIC below 0.003125 mg/mL (equal to 0.0375 μg Ag/mL) which was almost the detection limit in tests against S. aureus. Based on the above results, SBA-15_NH₂_{_}Ag has great antimicrobial activities against microorganisms in clinic, that would be potential composites for medical applications, such as antibacterial coatings of medical devices and instruments.

TABLE 10

| | | | MIC | |
|---|---|---|---|---|
| Bacterial species | Property | Strain names | (mg/mL) | (μg Ag/mL) |
| Acinetobacter baumannii | GNB | ATCC 19606 | 0.0125 | 0.15 |
| Klebsiella pneumoniae | GNB | ATCC 13883 | 0.0125 | 0.15 |
| Escherichia coli | GNB | ATCC 25922 | 0.00625 | 0.075 |
| Pseudomonas aeruginosa | GNB | ATCC 27853 | 0.0125 | 0.15 |
| Enterococcus faecalis | GPC | ATCC 29212 | 0.1 | 1.2 |
| Enterococcus faecium | GPC | ATCC 19434 | 0.00625 | 0.075 |
| Staphylococcus aureus | GPC | ATCC 25923 | ≦0.003125 | ≦0.0375 |

GNB: Gram-negative bacilli.
GPC: Gram-positive cocci.

### Example 4: Synthesis of Pore-Expanded Mesoporous Silica Nanoparticles

Pore-expanded Mesoporous Silica Nanoparticles as denoted as MSN_Ex was synthesized by a soft-template method using decane as a pore-expanding reagent. First, 0.772 g of cetyltrimethylammonium bromide (CTAB) was mixed in 320 g of H₂O at 50° C., and 2.4 mL of decane was dissolved in 24 g of ethanol, respectively. Aqueous CTAB solution was mixed with the ethanol solution and formed oil-in-water (O/W) emulsions. The microemulsions were stirred at 50° C. for 12 h, and then 5.96 g of NH₄OH (35 wt %) was added under stirring for 10 mins. Then, 6.68 mL of TEOS/ethanol solution (29 wt %) was added under stirring at 50° C. for 1 h. The solution was aged at 50° C. for 20 h. The as-synthesized products were filtered to remove side products. After that, the solution was hydrothermally treated at 80° C. for 24 h. To remove CTAB templates, precipitates were dispersed in 50 mL of HO/ethanol (5 mg/mL) and stirred at 50° C. for 2 h. Products were washed with ethanol and stored in 99.5% ethanol A dip coating method and Fourier filtering were applied to reconstruct an original HRTEM image to characterize the as-formed hydrophilic superstructures of the carbon dots.

Characterization of the Pore-Expanded Mesoporous Silica Nanoparticles

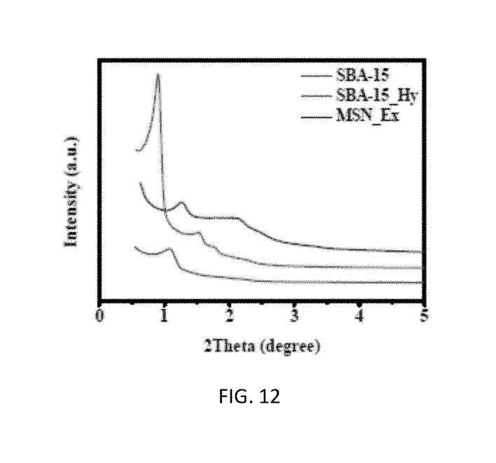

Powder X-ray diffraction patterns of mesoporous silica as shown FIG. 12 all exhibit mesostructures with Bragg reflection peaks. SBA-15 has a reflection peak at 1.07°, showing a cell parameter 12.6 nm. SBA-15_Hy which were hydrothermally treated has three reflection peaks at 0.897°, 1.53°, and 1.73°, presenting 2D-hexagonal (p6 mm) structures and a cell parameter 11.4 nm. MSN_Ex has a reflection peak at 1.25°, showing a cell parameter 8.19 nm.

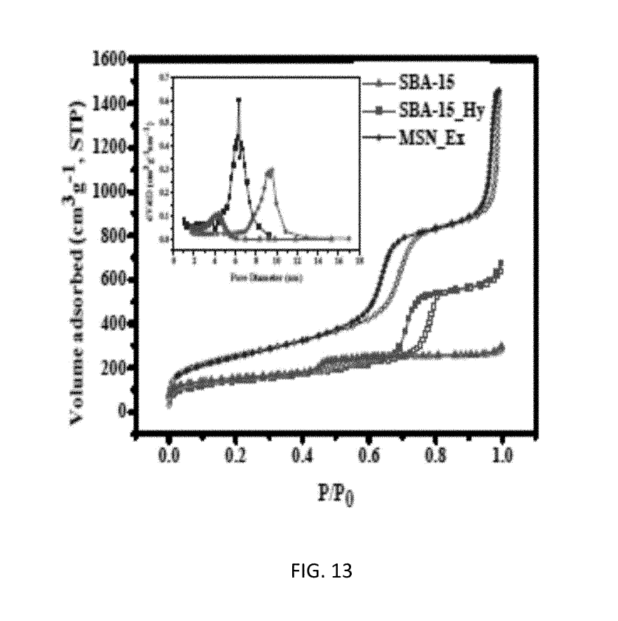

Nitrogen adsorption-desorption isotherms of these mesoporous silica materials all give typical type IV adsorption isotherms as shown in FIG. 13. The physical parameters of samples are summarized in Table 11. SBA-15 has a BET surface area of 524 m²/g and a BJH pore size of 4.4 nm. SBA-15_Hy has a specific surface area of 509 m²/g similar with SBA-15 and shows a major capillary condensation step at a high relative pressure around 0.75, implying the existence of large mesopores around 9.6 nm in comparison of SBA-15. MSN_Ex has a great BET surface area of 907 m²/g which is attributed to a rising of adsorption at a relative pressure range from 0.05 to 0.3 and a pore diameter of 6.2 nm. Capillary condensation occurred at relative pressure about 0.9 to 1.0 were attributed to the textural porosity (interparticle spacing) of nanoparticles.

TABLE 11

| | S_{BET} | Dₚₒᵣₑ | Vₜ | a₀ | w |
|---|---|---|---|---|---|
| Sample | (m²/g)^{a} | (nm)^{b} | (cm³/g)^{c} | (nm)^{d} | (nm)^{e} |
| SBA-15 | 524 | 4.4 | 0.29 | 12.6 | 8.2 |
| SBA-15_Hy | 507 | 9.6 | 0.93 | 11.4 | 1.8 |
| MSN_Ex | 907 | 6.2 | 1.11 | 8.19 | 2.0 |

^{a}surface area calculated by BET method at relative pressure of P/P0 = 0.05 − 0.3
^{b}pore size calculated by BJH method from adsorption branch of isotherms
^{c}mesopore volume deduced from BJH adsorption cumulative volume of pores between 1.0 nm and 30 nm
^{d}value of unit cell parameter
^{e}wall thickness

### Example 5: Preparation of Lysozyme Silica Biocomposite

A general procedure is as follows. 10 mg of the mesoporous silica substrate prepared from the example 1 or example 4 were mixed with 20 mL of 400 mg/L lysozyme solution at different pH 4.6, 6.8 and 9.5 in sodium phosphate buffer with different concentration of 20, 100 and 500 mM for evaluation the lysozyme adsorption. The solutions were shaken at room temperature for 24 hours. Then, the mixtures were centrifuged and the lysozyme silica biocomposite was obtained by a centrifugation separation step. The residual concentrations of lysozyme in the supernatants were measured by UV-vis spectrometer at 280 nm to quantify loading amounts of lysozyme in silica.

In order to optimize lysozyme adsorption, different process parameters, such as pH and ionic strength of the buffer solution were investigated. Because traditionally conjugate the antimicrobial peptides and proteins (AMPs) on a support by a covalent bond, it make the conformation of AMPs changed or the active site of AMPs be masked and lead to decrease the antimicrobial ability. In the present invention, we confine the AMPs including but not limited to lysozyme in the pore of silica support to avoid the lysozyme leaking out. The residues of most of the AMPs are less than 50 amino acids, the smaller molecules of AMPs are more easier loading into the pore of silica support than larger molecules. Therefore, we use the lysozyme a larger molecule of AMPs to proof the concept of we could modify the pore size and surface properties for confining the AMPs in the pore of silica support.

The driving force of lysozyme adsorption to silica would be the electrostatic interaction. Accordingly, the protein binding strength and limiting adsorption are strongly dependent on pH and ionic strength under adsorption condition. In this study, these factors were adjusted to get a great lysozyme uptake, and SBA-15_Hy was chosen as a model for enzyme loading

The Effect of Different pH Condition for Lysozyme Adsorption

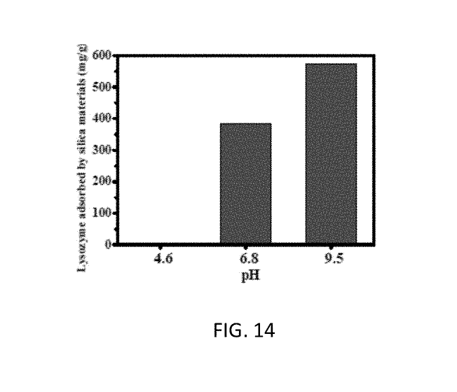

The isoelectric points (pI) of lysozyme and silica are around 11 and 2.0, respectively. However, silica would dissolve in saline solution with a pH over 10. Thus, positively charged lysozyme could be easily adsorbed on the negatively charged surface of silica in a pH range from 2.0 to 10 without decomposition of silica. Here, we performed the enzyme adsorption at pH 4.6, 6.8, and 9.5 under 400 mg/L lysozyme in 20 mM sodium phosphate buffer. The enzyme-loading capacity of silica was quantified through adsorption of supernatants measured by UV-vis spectrometer at 280 nm. It was found that only 0.195 mg protein was adsorbed onto per gram of silica at pH 4.6 as shown in FIG. 14. When the pH value was increased to 6.8, there was more enzyme uptake in silica around 384 mg/g, implying that the electrostatic interaction between silica and proteins was stronger. The highest loading amount 572 mg/g was acquired at pH 9.5 near to pI of lysozyme, which means that the electrostatic interaction between silica and proteins came to the strongest attraction.

The Effect of Different Ionic Strength for Lysozyme Adsorption

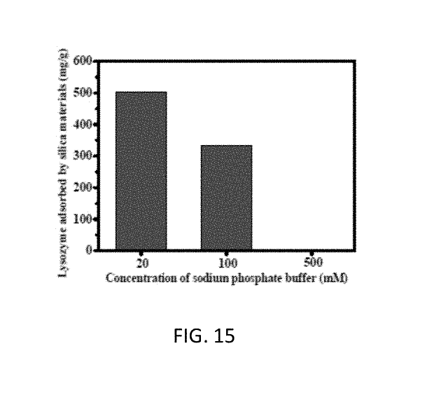

Ionic strength of solution condition would also have an influence on the electrostatic interaction between silica and proteins due to the shielding of counter ions. In this part, enzyme adsorption was performed at pH 9.5 under 400 mg/L lysozyme in a serial concentration of 20, 100, and 500 mM sodium phosphate buffer as shown in FIG. 15. When the concentration of buffer was 20 mM, a vast uptake of 504 milligrams lysozyme per gram of silica was achieved, showing a strong protein binding strength. However, as the concentration of buffer was up to 100 mM, the enzyme adsorption was lowered to 333 mg/g. What is more, only a few proteins were adsorbed on the silica at strong ionic strength in 500 mM buffer, implying that much of counter ions in the solution weaken the electrostatic interaction of the host and guest. To get the highest loading amount, based on the aforementioned results, lysozyme adsorption was performed in a condition of pH 9.5 and 20 mM sodium phosphate buffer in the following experiments.

Lysozyme-Loading Capacities of the Invented Mesoporous Silica Substrates

2 mg mesoporous silica substrates were suspended in 2 mL lysozyme solution with different concentrations (150, 300, 600, 750, 1500, 3000 mg/L) at pH 9.5 in 20 mM sodium phosphate buffer. The solutions were shaken at room temperature for 24 hours. Then, the mixtures were centrifuged, and the residual concentrations of lysozyme in the supernatants were measured by UV-vis spectrometer at 280 nm to quantify loading amounts of lysozyme in silica and equilibrium concentrations of solutions. Products were denoted as SBA-15_Lys, SBA-15_Hy_Lys, and MSN_Ex_Lys, respectively.

In order to study lysozyme-loading capacities of the mesoporous silica substrate, 50 mg mesoporous silica substrate were suspended in 50 mL of 1000 mg/L lysozyme solution at pH 9.5 in 20 mM sodium phosphate buffer. The solutions were shaken at room temperature for 24 hours. Then, the mixtures were centrifuged, and the residual concentrations of lysozyme in the supernatants were measured by UV-vis spectrometer at 280 nm to quantify loading amounts of lysozyme in the mesoporous silica substrate.

In order to build the desorption curves, 1 mg lysozyme-silica composites were suspended in 2 mL phosphate buffered saline (PBS) solution at pH 7.4 under stirring. At desired time intervals, the mixtures were centrifuged, and the residual concentrations of lysozyme in the supernatants were measured by UV-vis spectrometer at 280 nm to quantify desorption amounts of lysozyme from the silica substrates.

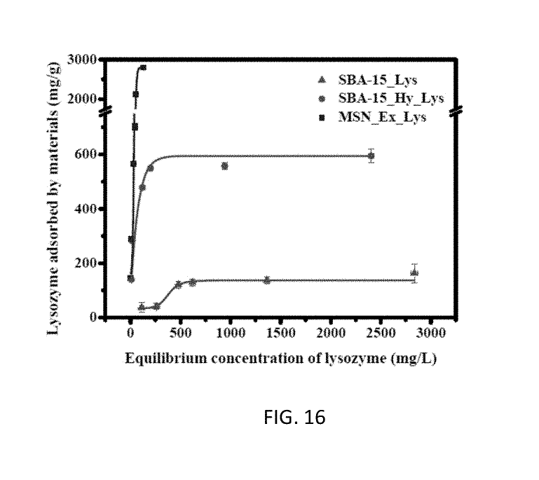

Adsorption curves were performed under a serial concentration of lysozyme at pH 9.5 in 20 mM sodium phosphate buffer using SBA-15, SBA-15_Hy, and MSN_Ex as different silica supports as shown in FIG. 16. SBA-15_Lyz could not get much of proteins absorbed to silica at first, while the adsorption curve reached a maximum uptake around 163 milligrams of lysozyme per gram of SBA-15 after the equilibrium concentration of enzyme solution was over 500 mg/L. The Langmuir-like adsorption curve of SBA-15_Hy_Lyz exhibited a burst uptake when the equilibrium concentration was below 450 mg/L, and then achieved a maximum capacity of 595 mg/g. On the other hand, the adsorption curve of MSN_Ex_Lyz continued to show an upward tendency with a protein uptake up to 2800 mg/g at equilibrium concentration of 130 mg/L.

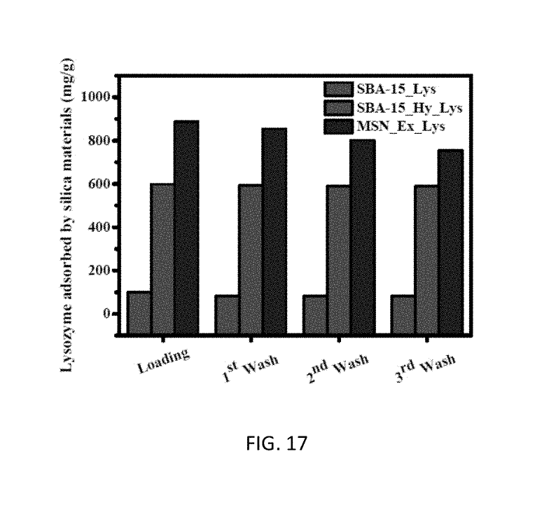

Based on the aforementioned experimental data, the enzyme loading under a condition in constant lysozyme concentration of 1000 mg/L at pH 9.5 in 20 mM sodium phosphate buffer that protein adsorption of SBA-15 and SBA-15_Hy would reach a maximum capacity was executed for evaluating enzyme-loading capacities of different mesoporous silica materials as shown in FIG. 17. SBA-15_Lyz had only 98.7 milligrams of lysozyme adsorbed per gram of silica at first and had a few lost after several washes with a final capacity of 82.4 mg/g. SBA-15_Hy_Lyz that had large mesopores up to 9.6 nm showed an enzyme uptake of 599 mg/g after loading, and had few lysozymes leaching from the composites during the washing process with a final capacity of 589 mg/g. For SBA-15 series, few enzyme leaching was obtained in washing process at first time, and no more leakage would be observed later, presenting that there were scarce multilayer protein molecules immobilized on external surface of silica. Nevertheless, MSN_Ex_Lyz revealed the highest enzyme uptake up to 888 mg/g among the silica materials. However, it had much of leakage of lysozyme about 45 mg/g during each wash procedure, implying that much multilayer protein molecules adsorbed on external surface of silica via weak Coulombic attraction were washed down continuously different from the former SBA-15 series. Hence, MSN_Ex_Lyz had a lower protein—loading capacity of 754 mg/g than it used to be

Pore Size Study of Silica Materials after Enzyme Loading

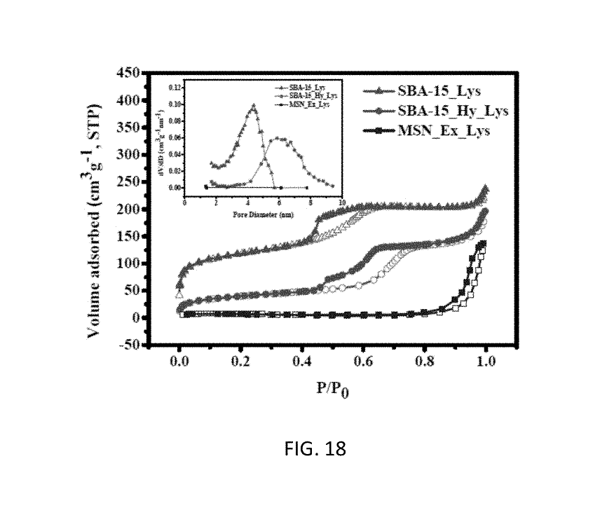

To evaluate the porosities of silica substrates after enzyme loading, nitrogen adsorption-desorption analysis was conducted and the results were compared to those of native silicas. It can be observed in FIG. 18 that all nitrogen adsorption curves of lysozyme-silica composites exhibited a remarkable reduction of amount of gas adsorbed, substantiating the successful protein immobilization of each silica material. For SBA-15_Lyz with enzyme uptake of 82.4 mg/g, it had only a reduction of specific surface areas from 524 to 405 m²/g without variation in pore size that maintained at 4.4 nm as shown in Table 12, implying that enzyme adsorption did not occur in the mesopores but merely on the external surface of SBA-15. This was possibly ascribed to the dimensions of lysozyme (3×3×4.5 nm³), which made them hard to penetrate into the narrow pores of SBA-15. Nevertheless, for SBA-15_Hy_Lyz, shrinkage of BET surface area from 507 to 142 m²/g and pore sizes from 9.6 to 5.9 nm were simultaneously obtained, presenting that lysozyme was not only adsorbed on the external surface but also encapsulated in mesopores of SBA-15_Hy. A similar result can be seen in MSN_Ex_Lyz. MSN_Ex_Lyz had a drastic decrease of BET surface area from 907 to 30.2 m²/g. Moreover, the mesopores of MSN_Ex were almost fully filled with enzyme so that the pore volume of MSN_Ex_Lyz was nearly down to zero. This result indicated multilayer protein adsorption on external surface of nanosized silica particles, as well as immobilization of protein in the mesopores.

TABLE 12

| | S_{BET} | Dₚₒᵣₑ | Vₜ |
|---|---|---|---|
| Sample | (m^{2/}g)^{a} | (nm)^{b} | (cm³/g)^{c} |
| SBA-15 | 524 | 4.4 | 0.29 |
| SBA-15_Hy | 507 | 9.6 | 0.93 |
| MSN_Ex | 907 | 6.2 | 1.1 |
| SBA-15_Lyz | 405 | 4.4 | 0.25 |
| SBA-15_Hy_Lyz | 142 | 5.9 | 0.28 |
| MSN_Ex_Lyz | 30.2 | 1.4 | 0.0081 |

^{a}surface area calculated by BET method at relative pressure of P/P0 = 0.05 − 0.3
^{b}pore size calculated by BJH method from adsorption branch of isotherms
^{c}mesopore volume deduced from BJH adsorption cumulative volume of pores between 1.0 nm and 30 nm

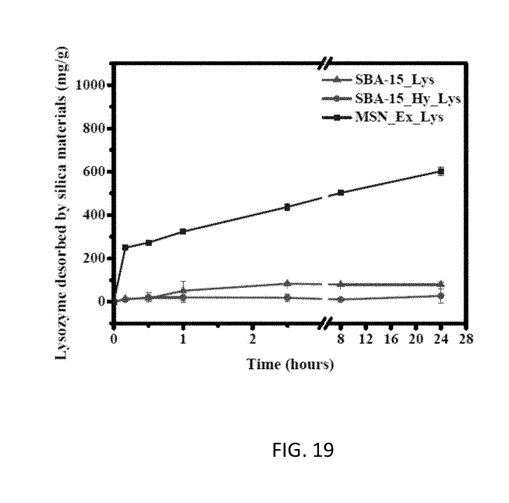

To determine the degree of lysozyme leaching from composites, time-dependent release profiles were conducted at pH 7.4 in PBS solution as shown in FIG. 19. SBA-15_Lyz maintained a total desorption amount around 80.5 mg/g after releasing for 1 hour and had a final enzyme amount of merely 1.81 mg/g after leaching for 24 hours, probably due to the narrow mesopores of SBA-15 having no ability for immobilizations of lysozyme and poor interactions between the host and guest. In contrast to SBA-15_Lyz, SBA-15_Hy_Lyz had quite few lysozyme of about 26.9 mg/g desorbed that it could keep a high protein-loading capacity of 562 mg/g. On the other hand, the enzyme desorption of MSN_Ex_Lyz was increasing from 250 up to 602 mg/g along with prolonging experiment time, indicating that the electrostatic interaction between multilayer protein molecules and silica was not strong enough for immobilizing the enzyme. Hence, MSN_Ex_Lyz finally got the enzyme amount of 152 mg/g, much lower than that of SBA-15_Hy_Lyz after leaching for 24 hours

### Example 6 Antibacterial Coating of Biocomposites

In this study, SBA-15_Hy_Lys was suspended in EtOH with a concentration of 0.5 mg/mL via ultrasonication. 40 μL of the mixture was then dropped on a glass slide with dimensions of 1×1 cm for spin-coating, which was performed at 1500 rpm for 30 sec twice. The lysozyme-silica composites were spin-coated on glass slides for inhibition of bacteria. SBA-15_Hy_Lyz, which had the highest protein-loading capacity with the least enzyme leaching among the silica materials, was used for antimicrobial coating as an experimental group, and SBA-15_Hy was coated as a control group without antibacterial agents.

Fluorescence (FL) Microscopy

Fluorescent images were collected by a Hitachi F-4500 spectrophotometer. The excitation/emission maxima for dyes are about 480/500 nm for SYTO 9 stain and 490/635 nm for propidium iodide.

Antibacterial Tests

In general, test glass slides with SBA-15_Hy or SBA-15_Hy_Lys coated were inculated with 25 μL inoculum of E. coli containing ˜5×10⁵ CFU/mL and 1 mM EDTA. Samples were incubated at 37° C. for 24 hours with humidity over 95% to avoid desiccation. After incubation, samples were washed with PBS gently twice. There were two characterization methods to evaluate inhibition of bacteria. For scanning electron microscopy, dehydration with a serial concentration of ethanol, critical point drying and platinum plating were processed. As for fluorescence microscopy, bacterial staining techniques were used to determine live and dead cells. Bacteria were all stained with green fluorescent dye (SYTO 9 green), and non-viable cells were stained with red fluorescent dye (propidium iodide).

Another inhibition test to confirm the antimicrobial activities of biocomposites was conducted. In brief, test glass slides with SBA-15_Hy or SBA-15_Hy_Lys coated were inculated with 25 μL inoculum of E. coli containing ˜10⁵ CFU/mL without EDTA. Samples were incubated at 37° C. for 24 hours with humidity over 95% to avoid desiccation. After incubation, bacterial cultures were washed out and the washing solution was subcultured into LB Broth for another incubation

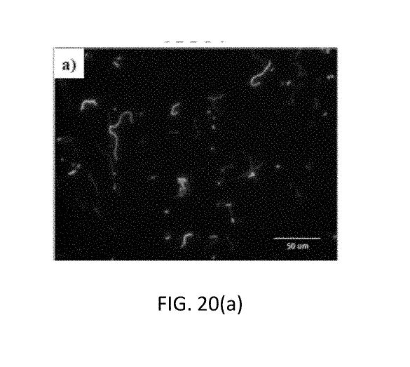

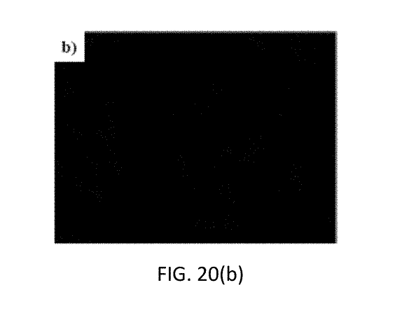

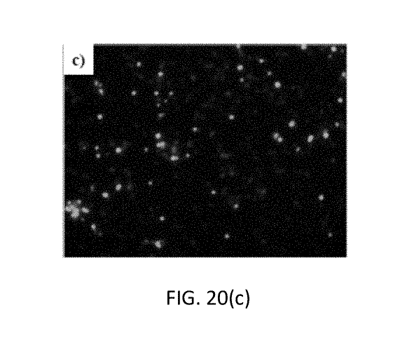

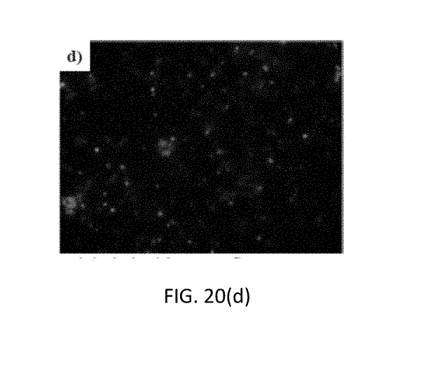

For evaluating of inhibition of bacteria of antimicrobial coating, bacterial staining techniques were utilized to determine live and dead cells. The bacteria were all stained with green fluorescent dye (SYTO 9 green), while only the non-viable cells would be stained with red fluorescent dye (propidium iodide). Both fluorescent dyes are nucleic acid stain. Images of bacteria attached on glass slides were recorded by a Hitachi F-4500 spectrophotometer. FIG. 20(a)˜(d) show: FL images of SBA-15_Hy and SBA-15_Hy_Lyz after incubation with E. coli. Bacteria with long string shape were labeled with green fluorescence in the image of SBA-15_Hy, illustrating the integrity of bacilliform structures without any bacteriolyzed phenomenon. However, many scraps of bacterial wreckages labeled with both green and red fluorescence could be seen in images of SBA-15_Hy_Lyz that had abundant lysozyme adsorbed as shown FIGS. 20(c) and (d), elucidating that E. coli were bacteriolyzed and injured. This result showed that the biocomposites had lytic ability against bacteria via attacking the cell walls of microorganisms by lysozyme, confirming the promising application of SBA-15_Hy_Lyz for antibacterial coating.

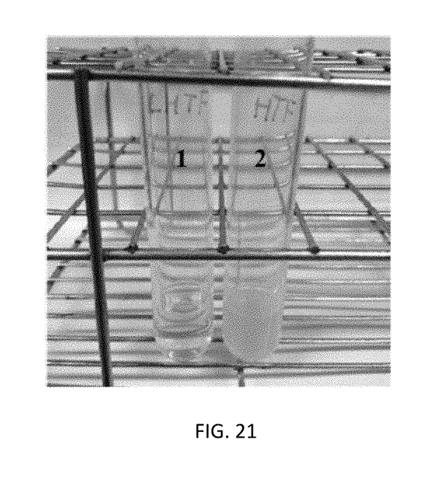

To confirm the antimicrobial activities of biocomposites, incubations by subculturing the washing of glass slides with materials coated after bacterial inhibition were performed as shown in FIG. 21. Especially, all bacterial incubation in the experiments proceeded without EDTA. For the result of SBA-15_Hy_Lyz, solution in tube #1 was clear without visible growth of colony, implying the bacteriolytic ability of SBA-15_Hy_Lyz. As for SBA-15_Hy, solution in tube #2 was turbid, representing overgrowth of bacteria and thus no inhibition effect.

To sum up, the present invention provides mesoporous silica materials as supports for immobilization of silver nanoparticles and a larger molecule of AMPs (lysozyme). In particularly, we successfully produced silver-immobilized mesoporous silica without employment of protecting agents. In the synthetic procedures of AgNPs, the regulation of particle size by adjusting the ratio of silver precursor and reducing conditions as well as the control of silver distribution on silica supports through post-modification of silica surface with various functional groups were carefully investigated. In bacterial inhibition tests, the silver-silica composites had quite low MICs against E. coli. SBA-15_NH₂_{_}Ag that showed the best bactericidal efficacy was further loaded on different substrates as antimicrobial coating for ISO tests, exhibiting excellent antibacterial defense. Besides, silver ion releasing test was executed that SBA-15_NH₂_{_}Ag had only 0.47 ppm of silver released in PBS solution at 37° C., which is desirable for prolonged usage. Moreover, the inhibition ability of SBA-15_NH₂_{_}Ag was also tested against various clinical microorganisms, and an extremely low MIC less than 0.003125 mg/mL (equal to 0.0375 μg Ag/mL) against S. aureus was achieved. With high bactericidal efficiency and low consumption of silver, SBA-15_NH₂_{_}Ag having platelet form shows great advantage for antimicrobial coating.

Secondly, for immobilization of lysozyme, mesoporous silica materials with varied dimensions and pore sizes were utilized as supports for enzyme loading, simply by Coulombic attractions between the silica and proteins. It was found that SBA-15 with pore size of 4.4 nm could not adopt protein immobilized in its nanochannels due to the large dimension of lysozyme, which make the protein hard to enter into narrow pores of silica. On the other hand, nanosized MSN_Ex, though presented much larger surface areas, had considerable multilayer protein molecules adsorbed on the external surface via weak electrostatic interaction. As for micron-sized SBA-15_Hy with large mesopores, a high lysozyme-loading capacity up to 562 mg/g without remarkable leaching was achieved. The biocomposites were further spin-coated on glass slides for bacterial inhibition, showing great bacteriolytic capability.

In conclusion, the present invention provides these two kind of antimicrobial composite with different antibacterial mechanisms could be utilized in various applications, including but not limited to coating on various kinds of hard substrates and soft substrates of sanitary equipment, building materials, medical facilities, biological laboratory device, and furniture or as environmental control of bacteria. For example, the SBA-15_NH₂_{_}Ag composite can coat on tiles. Simply by spreading the composite on raw tiles followed with mild calcination, the material would be well integrated with the silica-based tiles. In this way, the composite would form an excellent antibiotic coating on the surface, making the tiles favorable for medical environments including operation room and intensive care unit.

While the invention has explained in relation to its preferred embodiments, it is well understand that various modifications thereof will become apparent to those skilled in the art upon reading the specification. Therefore, the invention disclosed herein intended to cover such modifications as fall within the scope of the appended claims.

What is claimed is:

1. A composite, consisting essentially of a mesoporous silica substrates and silver nanoparticles, wherein the mesoporous silica substrate comprises a mesoporous silica thin film with perpendicular nanochannels and mesoporous silica nanoparticles with perpendicular nanochannels and wherein the silver nanoparticles non-covalently bond onto surface of the mesoporous silica substrate and have a distribution density of 10⁷-10¹³ number/cm² on the surface.

2. The composite of claim 1, wherein the mesoporous silica substrate has an average pore diameter ranges between 2 and 15 nm.

3. The composite of claim 1, having a two-dimension hexagonal packing diffraction pattern with the space group of p6 mm in FFT-TEM (fast Fourier transform) analysis.

4. The composite of claim 1, wherein the surface of the mesoporous silica substrate comprises amino group.

5. The composite of claim 1, wherein the silver nanoparticles have an average diameter less than 20 nm.

6. The composite of claim 1, being part of an antibacterial paint, medical device or sanitary equipment.

7. The composite of claim 6, wherein the antibacterial paint apply to one comprises cell culture dish, endoscopy, denture, surgical instrument and medical device.

8. A process for preparing an antibacterial composite, the process comprising:
(1) Providing a mesoporous silica substrate comprises a mesoporous silica thin film with perpendicular nanochannels and mesoporous silica nanoparticles with perpendicular nanochannels;
(2) Treating the mesoporous silica substrate with an silane to obtain an amino functionalizing silica substrate, wherein the silane form Si—O bonds on the mesoporous silica substrate;
(3) Adding a silver ion precursor into a medium contains the amino functionalizing silica substrate; and
(4) Adding a reductant to have the silver ion precursor in the medium form silver nanoparticles, wherein the silver nanoparticles non-covalently bond onto surface of the amino functionalizing silica substrate to construct an antibacterial composite which has a distribution density of the silver nanoparticles being 10⁷-10¹³ number/cm² on the surface of the amino functionalizing silica substrate.

9. The process of claim 8, wherein the silane comprises (3-aminopropyl)trimethoxysilane, N-[3-(trimethoxysilyl)propyl]ethylenediamine.

10. The process of claim 8, wherein the silver ion precursor is silver nitrate.

11. The process of claim 10, wherein a concentration of the silver nitrate is 0.1-3.0 mM.

12. The process of claim 8, wherein the reductant comprises 0.1-10 mM of sodium borohydride.

13. A method for inhibiting growth of bacteria on surfaces, comprising
(1) Providing a composition comprises an effective concentration of one selected from the group consisting of an antibacterial enzyme-silica biocomposites, silver-silica composites and its combination thereof; and
(2) Coating the composition on surfaces of a substrate to inhibit growth of the bacteria on the surfaces.

14. The method of claim 13, wherein the antibacterial enzyme-silica biocomposites consist of a lysozyme and a mesoporous silica substrate selected from a mesoporous silica thin film with perpendicular nanochannels and mesoporous silica nanoparticles with perpendicular nanochannels, wherein an average pore diameter of the mesoporous silica substrate is between 1 and 15 (nm.

15. The method of claim 13, wherein the antibacterial enzyme biocomposites comprise 50-3000 mg of lysozyme per gram of the antibacterial enzyme-silica biocomposites.

16. The method of claim 13, wherein the silver-silica composites have a concentration of released the silver ion less than 0.6 ppm.

17. The method of claim 13, wherein the silver-silica composites consist of silver nanoparticles and a mesoporous silica substrate selected from a mesoporous silica thin film with perpendicular nanochannels and mesoporous silica nanoparticles with perpendicular nanochannels, wherein an average pore diameter of the mesoporous silica substrate is between 1 and 15 nm.

18. The method of claim 17, wherein the silver nanoparticles non-covalently bond onto surface of the mesoporous silica substrate and have a distribution density of 10⁷-10¹³ number/cm² on the surface and an average diameter less than 20 nm.

19. The method of claim 17, wherein the mesoporous silica substrate has amino group on its surfaces

20. The method of claim 13, wherein the substrate comprises plastic, rubber, metal, ceramic, glass, swab, cotton, and cloth.
